(19) United States
(12) Patent Application Publication
(10) Pub. No.: US 2024/0166830 A1
(43) Pub. Date: May 23, 2024

(54) Electrolysis Film

(71) Applicant: Celanese International Corporation, Irving, TX (US)

(72) Inventors: Christian Ohm, Gernsheim (DE); David Ditter, Russelsheim (DE); Ludger Czyborra, Sulzbach (DE); Audrey Gensous, Sulzbach (DE)

(21) Appl. No.: 18/500,579

(22) Filed: Nov. 2, 2023

Related U.S. Application Data
(60) Provisional application No. 63/422,048, filed on Nov. 3, 2022.
(60) Provisional application No. 63/506,630, filed on Jun. 7, 2023.

(51) Int. Cl. C08J 5/18; C25B 13/08

(52) U.S. Cl. CPC C08J 5/18; C25B 13/08; C08J 2323/06

(57) ABSTRACT

A hydrophilic porous polymer film is disclosed that is particularly well-suited for use in an electrolysis cell producing hydrogen. The porous polymer film contains one or more high-density polyethylene polymers in combination with one or more hydrophilic additives. The porous film can be formed through a gel extrusion process or through sintering. Extremely thin films can be produced that have desired permeability characteristics, hydrophilicity characteristics, and mechanical characteristics necessary for use in the cell.

### RELATED APPLICATIONS

The present application is based upon and claims priority to U.S. Provisional Application Ser. No. 63/422,048, having a filing date of Nov. 3, 2022, and U.S. Provisional Application Ser. No. 63/506,630, having a filing date of Jun. 7, 2023, both of which are incorporated herein by reference.

### BACKGROUND

Recent advances in fuel cell technology and an increasing demand for fossil fuel alternatives has led to an increased need in the production of hydrogen. In addition to being used in fuel cells, hydrogen is also used to produce various different products, including ammonia, other fertilizers, and methanol.

When used as a fuel for a fuel cell, hydrogen reacts with oxygen and releases water. Thus, fuel cells can be configured to emit no greenhouse gases.

In one embodiment, hydrogen can be produced by the electrolysis of water according to a thermochemical cycle. Using water to produce hydrogen has various advantages and benefits. For example, hydrogen can be produced from water in a relatively pure state without any carbon dioxide emissions.

In one embodiment, hydrogen can be produced by electrolysis from aqueous solutions. For example, an alkaline solution can be used during electrolysis to produce hydrogen. The electrolysis of an alkaline solution can occur in cells that are partitioned by semi-permeable diaphragms or membranes. The diaphragm is positioned to separate an anode from a cathode and to prevent the recombination of hydrogen formed at the cathode and oxygen formed at the anode. The diaphragm, however, has been a limiting factor in the ability to efficiently produce hydrogen gas. For example, the membrane must be capable of withstanding operating pressures within the cell and must be suitable for use in high current density operations. The diaphragms also can be exposed to significant pH swings within the cell and therefore should be chemically resistant to acids and bases. In addition, the diaphragms should be highly ionically conductive for the transportation of hydroxyl ions from the cathode to the anode while remaining impermeable to hydrogen and oxygen gases.

Examples of diaphragms used in the past are disclosed, for instance, in U.S. Patent Publication 2022/0259751, and International Publications WO 2022/002999 and WO 2022/002904, which are all incorporated herein by reference. In the past, for instance, the diaphragms have been produced from porous polymer fabrics made from, for instance, polyphenylene sulfide fibers. The porous polymer fabric is then impregnated with a dope solution and used in a two-layer construction.

Although electrolysis cells have shown success in producing hydrogen, further improvements are still needed. In particular, a need exists for an improved semi-permeable diaphragm that can be positioned between the anode and the cathode in an electrolysis cell. For example, in one aspect, a need exists for a diaphragm well suited for use in an electrolysis cell that is lighter and/or thinner than the impregnated fabrics used in the past. In another aspect, a need also exists for a diaphragm for an electrolysis cell that comprises a single layer support. In still another aspect, a need exists for a diaphragm for an electrolysis cell that has an enhanced hydrophilic construction and/or properties.

### SUMMARY

In general, the present disclosure is directed to an improved diaphragm for use as a separator between an anode and a cathode. For example, the diaphragm is particularly well suited for use in electrolysis cells. In accordance with the present disclosure, the diaphragm can be formed from a porous film made from at least one high-density polyethylene polymer. The porous film can be produced through a gel extrusion process or through sintering and can incorporate at least one hydrophilic additive. Diaphragms made according to the present disclosure offer numerous advantages including being relatively lightweight, can function as a single layer diaphragm, have excellent semi-permeability properties in combination with good mechanical strength, and are chemically resistant.

For example, in one embodiment, the present disclosure is directed to a separator for dividing an anode from a cathode. The separator includes a porous polymer film that comprises a high-density polyethylene polymer having a number average molecular weight of greater than about 500,000 g/mol. For example, the average molecular weight of the polyethylene polymer can be greater than about 600,000 g/mol, such as greater than about 700,000 g/mol, such as greater than about 1,000,000 g/mol, such as greater than about 2,000,000 g/mol, such as greater than about 3,000,000 g/mol, such as greater than about 4,000,000 g/mol, such as greater than about 5,000,000 g/mol, and generally less than about 12,000,000 g/mol, such as less than about 10,000,000 g/mol.

The high-density polyethylene polymer can be combined with at least one hydrophilic additive and/or can be subjected to a plasma treatment for increasing the hydrophilic properties of the resulting film. The hydrophilic additive is present in the porous polymer film in an amount of at least about 5% by weight, such as in an amount of at least about 10% by weight, such as in an amount of at least about 20% by weight, such as in an amount of at least about 30% by weight, such as in an amount of at least about 40% by weight, such as in an amount of at least about 50% by weight, and generally in an amount less than about 90% by weight, such as in an amount less than about 70% by weight.

Alternatively, or in addition to, incorporating the hydrophilic additive into the film, at least the first surface of the porous polymer film can be plasma oxidized to form polar groups attached to the high-density polyethylene polymer. The polar groups increase the polarity of the surface of the porous polymer film. The plasma oxidized polar groups are present on the first surface of the film in an amount sufficient to increase the hydrophilic properties.

The porous film made according to the present disclosure can have a thickness of less than about 600 microns, such as less than about 500 microns, such as less than about 400 microns, such as less than about 300 microns, such as less than about 200 microns, such as less than about 150 microns, such as less than about 100 microns, such as less than about 80 microns and generally greater than about 5 microns, such as greater than about 10 microns, such as greater than about 20 microns, such as greater than about 30 microns.

As opposed to many diaphragms produced in the past, the separator of the present disclosure can be in the form of a film that is non-fibrous. In one embodiment, the porous polymer film can comprise an extruded film that has been stretched in at least one direction. For example, the film can be uniaxially stretched or biaxially stretched. Alternatively, the porous polymer film can comprise a sintered film.

As described above, the porous polymer film contains at least one hydrophilic additive. The hydrophilic additive, for instance, can comprise inorganic particles, a hydrophilically modified polymer, such as a hydrophilically modified polyethylene polymer, or mixtures thereof. Inorganic particles that can be incorporated into the film include silica, alumina, zirconium oxide, zirconium hydroxide, magnesium oxide, magnesium hydroxide, titanium oxide, titanium hydroxide, barium sulfate, or mixtures thereof. In one aspect, the hydrophilic additive comprises fumed silica. The inorganic particles can have a particle size (D50) of generally less than about 1 micron, such as less than about 0.8 microns, such as less than about 0.6 microns, such as less than about 0.5 microns, and greater than about 0.001 microns.

The porous polymer film containing the hydrophilic additive can be used alone as a single layer separator that may optionally include a coating. For instance, a hydrophilic coating can be applied to one or both sides of the film. The coating can comprise, for instance, a coating of silica, aluminum oxide, or zirconium oxide. In one aspect, the porous polymer film is polypropylene-free.

Porous polymer films made according to the present disclosure can have an average pore size of greater than about 0.005 microns and generally less than about 1 micron. The porous polymer film can have an ionic resistance of less than about 0.1 ohm·cm² at 80° C. in a 30 wt. % aqueous KOH solution.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 represents one embodiment of an electrolysis cell incorporating a separator that may be made in accordance with the present disclosure; and

FIG. 2 is one embodiment of an oxygen plasma process that may be used to treat porous polymer films in accordance with the present disclosure.

Repeat use of reference characters in the present specification and drawings is intended to represent the same or analogous features or elements of the present invention.

### DEFINITIONS

The melt flow rate of a polymer or polymer composition is measured according to ISO Test 1133 at 190° C. and at a load of 21.6 kg.

The density of a polymer is measured according to ISO Test 1183 in units of g/cm³.

Average particle size (d50) is measured using laser diffraction/light scattering, such as a suitable Horiba light scattering device.

The average molecular weight of a polymer is determined using the Margolies' equation.

Tensile modulus, tensile stress at yield, tensile strain at yield, tensile stress at 50% break, tensile stress at break, and tensile nominal strain at break are all measured according to ISO Test 527-2/1B.

Contact angle measurements are performed on a Krüss DSA 100 instrument. A membrane sample (10×40 mm) is attached to a microscope slide using double sided adhesive tape. Static charging is dissipated by moving the prepared sample several times through a U-electrode static discharger. The sample is mounted in a measurement device and a 3.5 μl droplet of testing fluid (water or ethyleneglycol) is placed on the membrane. The contact angle is determined through the software for 7 seconds (one measurement per second) after placement of the droplet. These 7 data points are averaged to yield the contact angle at the point of measurement. Every sample is measured at 6 different spots or locations on each side and all results are averaged to the reported value.

Porosity (%) is measured according to the following procedure. During the procedure, the following ASTM Standards are used as a reference: D622 Standard Test Method for Apparent Density of Rigid Cellular Plastics1; and D729 Standard Test Methods for Density and Specific Gravity (Relative Density) of Plastics by Displacement1. The following instruments are used: Calibrated Analytical Balance (0.0001 grams); Lorentzen & Wettre Micrometer, code 251 (0.1 um); and Deli 2056 art knife.

### Procedure

### 1.1. Samples and Sample Preparation

Using the specimen art knife, cut each sample material into a minimum of three 60 mm±0.5 by 60 mm±0.5 specimens

### 1.2. Instrument and Measurement

1.2.1 Using the L&W micrometer, take five readings of the thickness at each 60 mm by 60 mm specimen (average of 5 readings). Record this value as the thickness of this specimen.
1.2.2 Weigh the specimen directly on the balance. Record this value as the weight of this specimen.
1.2.3 The three specimens of the same sample are placed together and steps 1.2.1 and 1.2.2 are repeated to obtain the [bulk] thickness and the [bulk] weight.
Calculate the density to three significant figures as follows

$$\begin{matrix}a . D film = Density ( film ) = \frac{Wt . of Specimen}{{THK}^{*} Square} \\ D film = density of specimen , ( mg / mm 3 ) \\ Wt = weight of specimen , ( mg ) \\ THK = thickness of specimen , ( mm 2 ) \\ Square = area of specimen , ( mm 2 )\end{matrix}$$

$$\begin{matrix}b . D polymer = Density ( polymer ) 0.95 ( g / cm 3 ) \\ D polymer : Density of raw materials , without the pores .\end{matrix}$$

$$c . Porosity = {( 1 - D film / D polymer )}^{*} 100 \%$$

The pore diameter can be measured using the Bubble Point Test, corresponding to ASTM Test Method F316.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to hydrophilic porous films that are particularly well suited for use as diaphragms in electrolysis cells. The hydrophilic porous films are formed from one or more high-density polyethylene polymers. The one or more high-density polyethylene polymers have a relatively high molecular weight. The resulting porous films have excellent strength and selective permeability properties at decreased thicknesses in relation to conventional fibrous products used in the past.

During the electrolysis of water, electrical energy is transformed into hydrogen. The production of hydrogen from electrolysis continues to gain in importance and is a fundamental step and pillar in collaborative efforts to reduce greenhouse gas emissions and to decarbonize energy supplies. The hydrophilic porous films of the present disclosure are designed to separate an anode from a cathode within an electrolysis cell. The properties of the hydrophilic porous films are carefully controlled in order for the film to quickly wet and allow for the passage of electrolyte solutions while remaining substantially impermeable to the gases produced during the process, namely oxygen and hydrogen. Of particular advantage, hydrophilic porous films made according to the present disclosure have high porosity, high hydrophilicity, low gas permeability, and high oxidation resistance at a relatively low thickness. Various different methods and techniques can be used to increase the hydrophilic properties of the film. In addition, one or more heat stabilizers can be incorporated into the film.

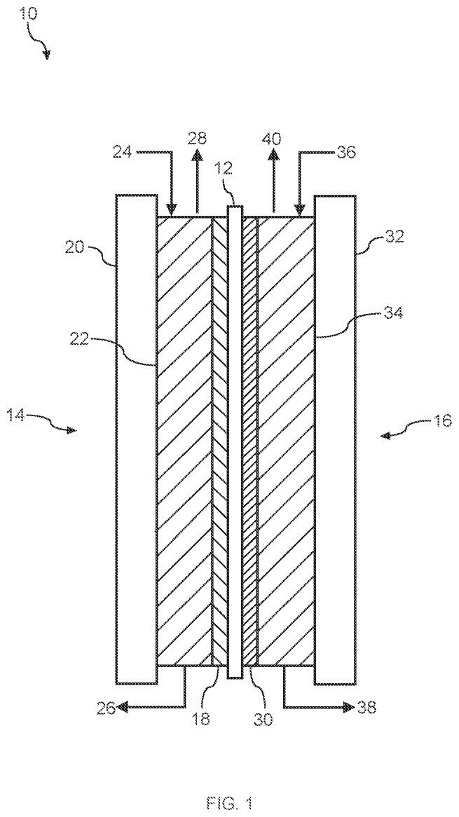

Referring to FIG. 1, one exemplary embodiment of an electrolysis cell 10 is shown. The electrolysis cell 10 includes a separator 12 made in accordance with the present disclosure. The separator 12, for instance, includes a hydrophilic porous film made from one or more high-density polyethylene polymers combined with one or more hydrophilic additives.

As shown in FIG. 1, the separator 12 separates an anode assembly 14 from a cathode assembly 16. The anode assembly 14 includes an anode 18. The anode 18 can be made from any suitable material, such as a porous metal structure. The porous metal structure, for instance, can comprise a mesh. In one aspect, the anode can include a catalyst layer. The catalyst layer may be different for the anode where oxygen is formed and the cathode where hydrogen is formed. The substrate used to produce the anode can be made from nickel, iron, soft steels, stainless steels, vanadium, molybdenum, copper, silver, manganese, platinum, graphite, chromium, or mixtures thereof. The catalyst layer, on the other hand, can include nickel, cobalt, iron, and platinum group elements. The above metals may exist in the catalyst layer as an oxide.

The anode 18 can be placed in direct contact with the separator 12 or can be spaced from the separator 12 to form a gap. The gap, for instance, can be less than about 5 mm, such as less than about 3 mm, such as less than about 2 mm.

The anode assembly 14 further includes an anodic plate 20 positioned adjacent to an anodic current collector 22. The anode 18 is in electrical communication with the anodic plate 20 via the anodic current collector 22. The anodic current collector 22, for instance, can be comprised of a porous metal structure. In one aspect, for instance, the anodic current collector 22 can comprise a nickel or steel porous foam or mat.

The anode assembly 14 defines a compartment that is designed to receive a flow of an aqueous solution. For instance, the anode assembly 14 can include an inlet 24 and a discharge 26. In one embodiment, an alkaline solution is fed through the electrolysis cell 10. The alkaline solution, for instance, can be a potassium hydroxide solution in one embodiment.

In the embodiment illustrated in FIG. 1, the inlet 24 is positioned at a top of the electrolysis cell 10 and the discharge 26 is positioned at the bottom of the electrolysis cell 10. In other embodiments, however, any suitable flow configuration can be used. During electrolysis, water is converted into hydrogen and oxygen. Oxygen is produced and accumulated within the anode assembly 14. As shown, oxygen 28 can be discharged from the electrolysis cell 10 in the form of a gas.

The cathode assembly 16 includes a cathode 30 in electrical communication with a cathodic plate 32 via a cathodic current collector 34. The cathode 30 can comprise any suitable structure, such as a porous web that contains a catalyst. The cathode 30, for instance, can be catalytically activated with platinum, palladium, or the like. The cathode 30 can comprise a single layer or can comprise multiple layers. As shown in FIG. 1, the cathode 30 can be placed in direct communication with the separator 12 and can be made from the same materials described above with respect to the anode 18.

The cathode 30 is electrically connected to the cathodic plate 32 by the cathodic current collector 34 in a manner that produces a compartment for the flow of fluids. The cathodic current collector 34 can have a similar structure to the anodic current collector 22 and can comprise, for instance, a porous metal structure. The cathode assembly 16 can include an inlet 36 and a discharge 38 for flowing an aqueous solution, such as a potassium hydroxide solution, through the cathode assembly 16. The aqueous solution fed through the cathode assembly 16 can be the same or different than the aqueous solution fed through the anode assembly 14.

During the process, hydrogen is produced within the cathode assembly 16. The hydrogen 40 can be discharged from the electrolysis cell 10 and collected.

Not shown, the electrolysis cell 10 can include various gaskets and attaching members for maintaining the cell in a consolidated arrangement. The electrolysis cell 10 can produce hydrogen 40 from water without producing any greenhouse gas emissions.

As described above, the separator 12 as shown in FIG. 1, is made from a high-density or high molecular weight hydrophilic porous polyethylene film. The hydrophilic porous film of the present disclosure can be made using different techniques and processes. For instance, in one embodiment, the hydrophilic porous film can be made in an extrusion process, such as a gel extrusion process. Alternatively, the hydrophilic porous film can be formed through a sintering process.

Hydrophilic porous films made according to the present disclosure possess numerous physical properties making them particularly well suited for use in the electrolysis cell 10 and also provide various advantages and benefits over fibrous materials used in the past.

For instance, high-density and high molecular weight polyethylene polymers offer a unique combination of chemical resistance, chemical neutrality, and mechanical strength. In addition, using the processes as described herein, the high-density polyethylene polymers can be combined with significant amounts of hydrophilic additives for producing porous films that quickly wet when contacted with water or an aqueous solution, such as a potassium hydroxide solution. For instance, hydrophilic porous films made according to the present disclosure are particularly well suited for contact with potassium hydroxide solutions containing potassium hydroxide in an amount from about 10% to about 40% by weight, such as in an amount from about 20% to about 35% by weight, and at a temperature of greater than about 50° C., such as greater than about 60° C., such as greater than about 70° C., such as greater than about 80° C., and generally less than about 95° C.

The hydrophilic porous film of the present disclosure has a pore structure that is well suited to preventing hydrogen gases and oxygen gases from recombining during the electrolysis process. The pore structure of the film, on the other hand, is permeable to hydroxyl ions from the cathode to the anode. In one aspect, the hydrophilic porous film has an average pore size of greater than about 0.005 microns, such as greater than about 0.05 microns, such as greater than about 0.1 microns, such as greater than about 0.15 microns, such as greater than about 0.2 microns, such as greater than about 0.25 microns, such as greater than about 0.3 microns, such as greater than about 0.35 microns, such as greater than about 0.4 microns, such as greater than about 0.45 microns, such as greater than about 0.5 microns. The average pore size is generally less than about 2 microns, such as less than about 1 micron, such as less than about 0.8 microns, such as less than about 0.7 microns, such as less than about 0.6 microns, such as less than about 0.5 microns.

The porosity of the hydrophilic film is generally greater than about 25%, such as greater than about 30%, such as greater than about 35%, such as greater than about 40%, such as greater than about 45%, such as greater than about 50%, such as greater than about 55%, and generally less than about 80%, such as less than about 70%, such as less than about 65%.

The hydrophilic porous film of the present disclosure is also heat resistant and pressure resistant. For instance, the hydrophilic porous film is well suited for continuous use at surface temperatures in the range of from about 60° C. to about 110° C., such as from about 75° C. to about 90° C., as may be experienced in the electrolysis cell. The hydrophilic porous film is also pressure resistant and offers excellent creep resistance. The porous film, for instance, can be continuously exposed to surface pressures of from about 35 bar to about 50 bar. In addition, the hydrophilic porous film of the present disclosure offers inherent flame resistance. When tested according to UL 94 Test, for instance, the film can display a VO rating at a thickness of only 0.3 mm.

The porous film of the present disclosure also has excellent wetting properties and is highly hydrophilic. For example, the porous film can display an ionic resistance of less than about 0.1 ohm·cm² at 80° C. in a 30% by weight aqueous potassium hydroxide solution. For instance, the ionic resistance of the film can be less than about 0.08 ohm·cm², such as less than about 0.06 ohm·cm² at the above conditions. The film can also display a contact angle when measured against water of less than about 110°, such as less than about 105°, such as less than about 102°, such as less than about 100°, such as less than about 98°, such as less than about 96°, such as less than about 94°, such as less than about 92°, such as less than about 90°, such as less than about 88°, such as less than about 86°, such as less than about 84°, such as less than about 82°, such as less than about 80°.

All of the above properties can be obtained at relatively low thicknesses. For instance, the porous film of the present disclosure can have a thickness of less than about 500 microns, such as less than about 400 microns, such as less than about 300 microns, such as less than about 200 microns, such as less than about 150 microns, such as less than about 100 microns. In one aspect, the thickness of the porous film can be less than about 90 microns, such as less than about 85 microns, such as less than about 80 microns, such as less than about 75 microns, such as less than about 70 microns, such as less than about 65 microns, such as less than about 60 microns. The thickness of the porous film is generally greater than about 5 microns, such as greater than about 10 microns, such as greater than about 20 microns, such as greater than about 25 microns, such as greater than about 30 microns, such as greater than about 35 microns, such as greater than about 40 microns, such as greater than about 45 microns, such as greater than about 50 microns, such as greater than about 55 microns, such as greater than about 60 microns.

As described above, the hydrophilic porous film of the present disclosure is formed from at least one high-density polyethylene polymer combined with at least one hydrophilic additive. The at least one high-density polyethylene can have a density of about 0.93 g/cm³ or greater, such as about 0.94 g/cm³ or greater, such as about 0.95 g/cm³ or greater, and generally less than about 1 g/cm³, such as less than about 0.97 g/cm³.

The high-density polyethylene polymer can be made from over 90% ethylene derived units, such as greater than 95% ethylene derived units, or from 100% ethylene derived units. The polyethylene can be a homopolymer or a copolymer, including a terpolymer, having other monomeric units.

The high-density polyethylene can be a high molecular weight polyethylene, a very high molecular weight polyethylene, and/or an ultrahigh molecular weight polyethylene. “High molecular weight polyethylene” refers to polyethylene compositions with an average molecular weight of at least about 3×10⁵ g/mol and, as used herein, is intended to include very-high molecular weight polyethylene and ultra-high molecular weight polyethylene. For purposes of the present specification, the molecular weights referenced herein are determined in accordance with the Margolies equation (“Margolies molecular weight”).

“Very-high molecular weight polyethylene” refers to polyethylene compositions with a weight average molecular weight of less than about 3×10⁶ g/mol and more than about 1×10⁶ g/mol. In some embodiments, the molecular weight of the very-high molecular weight polyethylene composition is between about 2×10⁶ g/mol and less than about 3×10⁶ g/mol.

“Ultra-high molecular weight polyethylene” refers to polyethylene compositions with an average molecular weight of at least about 3×10⁶ g/mol. In some embodiments, the molecular weight of the ultra-high molecular weight polyethylene composition is between about 3×10⁶ g/mol and about 30×10⁶ g/mol, or between about 3×10⁶ g/mol and about 20×10⁶ g/mol, or between about 3×10⁶ g/mol and about 10×10⁶ g/mol, or between about 3×10⁶ g/mol and about 6×10⁶ g/mol.

In one aspect, the high-density polyethylene is a homopolymer of ethylene. In another embodiment, the high-density polyethylene may be a copolymer. For instance, the high-density polyethylene may be a copolymer of ethylene and another olefin containing from 3 to 16 carbon atoms, such as from 3 to 10 carbon atoms, such as from 3 to 8 carbon atoms. These other olefins include, but are not limited to, propylene, 1-butene, 1-pentene, 1-hexene, 1-heptene, 1-octene, 4-methylpent-1-ene, 1-decene, 1-dodecene, 1-hexadecene and the like. Also, utilizable herein are polyene comonomers such as 1,3-hexadiene, 1,4-hexadiene, cyclopentadiene, dicyclopentadiene, 4-vinylcyclohex-1-ene, 1,5-cyclooctadiene, 5-vinylidene-2-norbornene and 5-vinyl-2-norbornene. However, when present, the amount of the non-ethylene monomer(s) in the copolymer may be less than about 10 mol. %, such as less than about 5 mol. %, such as less than about 2.5 mol. %, such as less than about 1 mol. %, wherein the mol. % is based on the total moles of monomer in the polymer.

In one embodiment, the high-density polyethylene may have a monomodal molecular weight distribution. Alternatively, the high-density polyethylene may exhibit a bimodal molecular weight distribution. For instance, a bimodal distribution generally refers to a polymer having a distinct higher molecular weight and a distinct lower molecular weight (e.g., two distinct peaks) on a size exclusion chromatography or gel permeation chromatography curve. In another embodiment, the high-density polyethylene may exhibit more than two molecular weight distribution peaks such that the polyethylene exhibits a multimodal (e.g., trimodal, tetramodal, etc.) distribution. Alternatively, the high-density polyethylene may exhibit a broad molecular weight distribution wherein the polyethylene is comprised of a blend of higher and lower molecular weight components such that the size exclusion chromatography or gel permeation chromatography curve does not exhibit at least two distinct peaks but instead exhibits one distinct peak broader than the individual component peaks.

Any method known in the art can be utilized to synthesize the polyethylene. The polyethylene powder is typically produced by the catalytic polymerization of ethylene monomer or optionally with one or more other 1-olefin co-monomers, the 1-olefin content in the final polymer being less or equal to 10% of the ethylene content, with a heterogeneous catalyst and an organo aluminum or magnesium compound as cocatalyst. The ethylene is usually polymerized in gaseous phase or slurry phase at relatively low temperatures and pressures. The polymerization reaction may be carried out at a temperature of between 50° C. and 100° C. and pressures in the range of 0.02 and 2 MPa.

The molecular weight of the polyethylene can be adjusted by adding hydrogen. Altering the temperature and/or the type and concentration of the co-catalyst may also be used to fine tune the molecular weight. Additionally, the reaction may occur in the presence of antistatic agents to avoid fouling and product contamination.

Suitable catalyst systems include but are not limited to Ziegler-Natta type catalysts. Typically, Ziegler-Natta type catalysts are derived by a combination of transition metal compounds of Groups 4 to 8 of the Periodic Table and alkyl or hydride derivatives of metals from Groups 1 to 3 of the Periodic Table. Transition metal derivatives used usually comprise the metal halides or esters or combinations thereof. Exemplary Ziegler-Natta catalysts include those based on the reaction products of organo aluminum or magnesium compounds, such as for example but not limited to aluminum or magnesium alkyls and titanium, vanadium or chromium halides or esters. The heterogeneous catalyst might be either unsupported or supported on porous fine grained materials, such as silica or magnesium chloride. Such support can be added during synthesis of the catalyst or may be obtained as a chemical reaction product of the catalyst synthesis itself.

In one embodiment, a suitable catalyst system can be obtained by the reaction of a titanium(IV) compound with a trialkyl aluminum compound in an inert organic solvent at temperatures in the range of −40° C. to 100° C., preferably −20° C. to 50° C. The concentrations of the starting materials are in the range of 0.1 to 9 mol/L, preferably 0.2 to 5 mol/L, for the titanium(IV) compound and in the range of 0.01 to 1 mol/L, preferably 0.02 to 0.2 mol/L for the trialkyl aluminum compound. The titanium component is added to the aluminum component over a period of 0.1 min to 60 min, preferably 1 min to 30 min, the molar ratio of titanium and aluminum in the final mixture being in the range of 1:0.01 to 1:4.

In another embodiment, a suitable catalyst system is obtained by a one or two-step reaction of a titanium(IV) compound with a trialkyl aluminum compound in an inert organic solvent at temperatures in the range of −40° C. to 200° C., preferably −20° C. to 150° C. In the first step the titanium(IV) compound is reacted with the trialkyl aluminum compound at temperatures in the range of −40° C. to 100° C., preferably −20° C. to 50° C. using a molar ratio of titanium to aluminum in the range of 1:0.1 to 1:0.8. The concentrations of the starting materials are in the range of 0.1 to 9.1 mol/L, preferably 5 to 9.1 mol/L, for the titanium(IV) compound and in the range of 0.05 and 1 mol/L, preferably 0.1 to 0.9 mol/L for the trialkyl aluminum compound. The titanium component is added to the aluminum compound over a period of 0.1 min to 800 min, preferably 30 min to 600 min. In a second step, if applied, the reaction product obtained in the first step is treated with a trialkyl aluminum compound at temperatures in the range of −10° C. to 150° C., preferably 10° C. to 130° C. using a molar ratio of titanium to aluminum in the range of 1:0.01 to 1:5.

In yet another embodiment, a suitable catalyst system is obtained by a procedure wherein, in a first reaction stage, a magnesium alcoholate is reacted with a titanium chloride in an inert hydrocarbon at a temperature of 50° to 100° C. In a second reaction stage, the reaction mixture formed is subjected to heat treatment for a period of about 10 to 100 hours at a temperature of 110° to 200° C. accompanied by evolution of alkyl chloride until no further alkyl chloride is evolved, and the solid is then freed from soluble reaction products by washing several times with a hydrocarbon.

In a further embodiment, catalysts supported on silica, such as for example the commercially available catalyst system Sylopol® 5917 can also be used.

Using such catalyst systems, the polymerization is normally carried out in suspension at low pressure and temperature in one or multiple steps, continuous or batch. The polymerization temperature is typically in the range of 30° C. to 130° C., preferably is the range of 50° C. and 90° C. and the ethylene partial pressure is typically less than 10 MPa, preferably 0.05 and 5 MPa. Trialkyl aluminums, like for example but not limited to isoprenyl aluminum and triisobutyl aluminum, are used as co-catalyst such that the ratio of Al:Ti (co-catalyst versus catalyst) is in the range of 0.01 to 100:1, more preferably is the range of 0.03 to 50:1. The solvent is an inert organic solvent as typically used for Ziegler type polymerizations. Examples are butane, pentane, hexane, cyclohexene, octane, nonane, decane, their isomers and mixtures thereof. The polymer molecular mass is controlled through feeding hydrogen. The ratio of hydrogen partial pressure to ethylene partial pressure is in the range of 0 to 50, preferably the range of 0 to 10. The polymer is isolated and dried in a fluidized bed drier under nitrogen. The solvent may be removed through steam distillation in case of using high boiling solvents. Salts of long chain fatty acids may be added as a stabilizer. Typical examples are calcium, magnesium and zinc stearate.

Optionally, other catalysts such as Phillips catalysts, metallocenes and post metallocenes may be employed. Generally, a cocatalyst such as alumoxane or alkyl aluminum or alkyl magnesium compound is also employed. Other suitable catalyst systems include Group 4 metal complexes of phenolate ether ligands.

In one embodiment, the polyethylene particles are made from a polyethylene polymer having a relatively low bulk density as measured according to DIN53466. For instance, in one embodiment, the bulk density is generally less than about 0.4 g/cm³, such as less than about 0.35 g/cm³, such as less than about 0.33 g/cm³, such as less than about 0.3 g/cm³, such as less than about 0.28 g/cm³, such as less than about 0.26 g/cm³. The bulk density is generally greater than about 0.1 g/cm³, such as greater than about 0.15 g/cm³. In one embodiment, the polymer has a bulk density of from about 0.2 g/cm³ to about 0.27 g/cm³.

In one embodiment, the polyethylene particles can be a free-flowing powder. The particles can have a median particle size (d50) by volume of less than 600 microns, such as less than about 500 microns, such as less than about 400 microns, such as less than about 300 microns. For example, the median particle size (d50) of the polyethylene particles can be less than about 150 microns, such as less than about 125 microns. The median particle size (d50) is generally greater than about 20 microns. The powder particle size can be measured utilizing a laser diffraction method according to ISO 13320.

In one embodiment, 90% of the polyethylene particles can have a particle size of less than about 800 microns, such as less than about 700 microns, such as less than about 600 microns, such as less than about 500 microns, such as less than about 400 microns, such as less than about 300 microns, such as less than about 250 microns, and generally greater than about 50 microns, such as greater than about 100 microns, such as greater than about 200 microns.

The molecular weight of the polyethylene polymer can vary depending upon the particular application. The polyethylene polymer, for instance, may have an average molecular weight, as determined according to the Margolies equation. The molecular weight can be determined by first measuring the viscosity number according to DIN EN ISO Test 1628. Dry powder flow is measured using a 25 mm nozzle. The molecular weight is then calculated using the Margolies equation from the viscosity numbers. The average molecular weight is generally greater than about 500,000 g/mol, such as greater than about 600,000 g/mol, such as greater than about 650,000 g/mol, such as greater than about 1,000,000 g/mol, such as greater than about 2,000,000 g/mol, such as greater than about 2,500,000 g/mol, such as greater than about 3,000,000 g/mol, such as greater than about 4,000,000 g/mol. The average molecular weight is generally less than about 12,000,000 g/mol, such as less than about 10,000,000 g/mol. In one aspect, the number average molecular weight of the high-density polyethylene polymer can be less than about 4,000,000 g/mol, such as less than about 3,000,000 g/mol.

The polyethylene may have a viscosity number of from at least 500 mL/g, such as at least 700 mL/g, such as at least 1,000 mL/g, to less than about 6,000 mL/g, such as less than about 5,000 mL/g, such as less than about 4,000 mL/g, such as less than about 3,000 mL/g, such as less than about 2,000 mL/g, as determined according to ISO 1628 part 3 utilizing a concentration in decahydronapthalene of 0.0002 g/mL.

The high-density polyethylene may have a crystallinity of from at least about 40% to 85%, such as from 45% to 80%. In one aspect, the crystallinity can be greater than about 50%, such as greater than about 55%, such as greater than about 60%, such as greater than about 65%, such as greater than about 70%, and generally less than about 80%.

In producing hydrophilic porous films in accordance with the present disclosure, various different techniques and processes can be used to increase the hydrophilic properties of the film. In one aspect, one or more high-density polyethylene polymers as described above can be combined with one or more hydrophilic additives. Alternatively, or in addition to incorporating a hydrophilic additive into the film, the film or polymer can be plasma oxidized to increase the hydrophilic properties.

In one aspect, the high-density polyethylene particles are mixed or blended with at least one hydrophilic additive and then formed into the film. One or more hydrophilic additives are incorporated into the film generally in an amount greater than about 5%, such as greater than about 10% by weight, such as in an amount greater than about 20% by weight, such as in an amount greater than about 30% by weight, such as in an amount greater than about 35% by weight, such as in an amount greater than about 40% by weight, such as in an amount greater than about 45% by weight, such as in an amount greater than about 50% by weight, such as in an amount greater than about 55% by weight, such as in an amount greater than about 60% by weight, such as in an amount greater than about 65% by weight. One or more hydrophilic additives are generally present in the film in an amount less than about 90% by weight, such as in an amount less than about 85% by weight, such as in an amount less than about 80% by weight, such as in an amount less than about 75% by weight, such as in an amount less than about 70% by weight, such as in an amount less than about 65% by weight.

In one aspect, the hydrophilic additive can comprise inorganic particles. The inorganic particles, for instance, can comprise oxide particles, hydroxide particles, sulfate particles, and the like. For instance, the inorganic particles can comprise metal oxide particles, metal hydroxide particles, or mixtures thereof.

Examples of hydrophilic additives that can be incorporated into the film of the present disclosure include particles made from silica, alumina, zirconium oxide, zirconium hydroxide, magnesium oxide, magnesium hydroxide, titanium oxide, titanium hydroxide, barium sulfate, or mixtures thereof. Still other examples of hydrophilic additives include particles of bismuth oxide, cerium oxide, bismuth hydroxide, cerium hydroxide, and/or nitrides and/or carbides of Group IV elements of the Periodic Table.

In one particular embodiment, the hydrophilic additive comprises fumed silica particles or precipitated silica particles.

The inorganic particles generally have a small particle size. For instance, the particles can have an average particle size (D50) of less than about 20 microns, such as less than about 15 microns, such as less than about 10 microns, such as less than about 5 microns, such as less than about 2 micron, such as less than about 1 micron, such as less than about 0.8 microns, such as less than about 0.7 microns, such as less than about 0.6 microns, such as less than about 0.5 microns, such as less than about 0.4 microns, such as less than about 0.3 microns, such as less than about 0.2 microns, such as less than about 0.1 microns. The particle size is generally greater than about 0.01 microns, such as greater than about 0.05 microns, such as greater than about 0.1 micron. In one aspect, the particle size is generally greater than about 2 microns, such as greater than about 5 microns, such as greater than about 8 microns.

The one or more inorganic hydrophilic particles can be present in the porous polymer film in an amount of at least about 5% by weight, such as in an amount of at least about 10% by weight, such as in an amount of at least about 20% by weight, such as in an amount of at least about 30% by weight, such as in an amount of at least about 40% by weight, such as in an amount of at least about 50% by weight, such as in an amount of at least about 60% by weight, such as in an amount of at least about 70% by weight, and generally in an amount less than about 90% by weight, such as in an amount less than about 75% by weight. In some embodiments, the high-density polyethylene particles serve as a binder for the inorganic particles.

Instead of or in addition to inorganic particles, the hydrophilic additive can also comprise a hydrophilic polymer, such as a hydrophilically modified thermoplastic polymer. The hydrophilically modified polymer, for instance, may comprise a polymer in which hydrophilic groups have been grafted to the polymer chain. The hydrophilically modified polymer can comprise a hydrophilically modified high-density polyethylene polymer. The high-density polyethylene polymer can have any of the characteristics described above with respect to the polyethylene polymer used to form the matrix of the film.

In one aspect, the hydrophilic additive can comprise a polyolefin polymer particularly a polyethylene polymer functionalized with an organic acid, such as an organic acid anhydride. For example, the polyolefin polymer, such as a polyethylene polymer, can be modified to include hydrophilic carboxyl groups. The carboxyl groups can be added to the polymer by oxidation, by polymerization, or by grafting. For example, in one aspect, carboxyl-containing unsaturated monomers can be grafted to a polyolefin polymer, such as a polyethylene polymer. The carboxyl-containing unsaturated monomer, for instance, can be maleic acid anhydride.

For example, in one aspect, the hydrophilic additive can be a polyethylene polymer functionalized with maleic acid anhydride. The polyethylene polymer can be the same as the high-density polyethylene polymer that is combined with the hydrophilic additive or can be a different polyethylene polymer. For example, the polyethylene polymer functionalized with the maleic acid anhydride can be a low density polyethylene polymer, such as a linear low density polyethylene polymer. Alternatively, the polyethylene polymer functionalized with the maleic acid anhydride can be a high-density polyethylene polymer. The high-density polyethylene polymer can have a molecular weight of greater than about 300,000 g/mol, such as greater than about 500,000 g/mol, such as greater than about 700,000 g/mol, and generally less than about 12,000,000 g/mol.

The polyethylene functionalized with the maleic acid anhydride can contain maleic acid anhydride in an amount generally greater than about 1.5% by weight, such as in an amount greater than about 1.8% by weight, such as in an amount greater than about 2% by weight, such as in an amount greater than about 2.5% by weight, such as in an amount greater than about 3% by weight, such as in an amount greater than about 3.5% by weight, such as in an amount greater than about 4% by weight, such as in an amount greater than about 4.5% by weight, such as in an amount greater than about 10% by weight, such as in an amount greater than about 20% by weight. The polyethylene functionalized with maleic acid anhydride generally can contain the maleic acid anhydride in an amount less than about 60% by weight, such as less than about 50% by weight, such as less than about 40% by weight, such as less than about 20% by weight, such as in an amount less than about 10% by weight, such as in an amount less than about 8% by weight, such as in an amount less than about 5% by weight. The polyethylene functionalized with maleic acid anhydride can be in the form of a powder or particles that are combined or compounded with the high-density polyethylene particles.

In other embodiments, the hydrophilic additive can be a fatty alcohol glycol ether such as an ethylene-vinyl alcohol copolymer. The hydrophilic additive can also be an ethylene acrylic acid copolymer. The ethylene acrylic acid copolymer can generally have an acrylic acid content of greater than 5% by weight, such as greater than about 8% by weight, such as greater than about 10% by weight, and generally less than about 30% by weight, such as less than about 20% by weight, such as less than about 15% by weight, such as less than about 12% by weight.

The hydrophilic additive can be any suitable acrylate polymer and/or a graft copolymer containing an olefin. The olefin polymer, such as polyethylene, can serve as a graft base and can be grafted to at least one vinyl polymer or one ether polymer.

Examples of hydrophilic additives as described above include ethylene-acrylic acid copolymer, ethylene-maleic anhydride copolymers, ethylene-alkyl(meth)acrylate-maleic anhydride terpolymers, ethylene-alkyl(meth)acrylate-glycidyl(meth)acrylate terpolymers, ethylene-acrylic ester-methacrylic acid terpolymer, ethylene-acrylic ester-maleic anhydride terpolymer, ethylene-methacrylic acid-methacrylic acid alkaline metal salt (ionomer) terpolymers, and the like. In one embodiment, for instance, a hydrophilic additive can include a random terpolymer of ethylene, methylacrylate, and glycidyl methacrylate. The terpolymer can have a glycidyl methacrylate content of from about 5% to about 20%, such as from about 6% to about 10%. The terpolymer may have a methylacrylate content of from about 20% to about 30%, such as about 24%.

In one aspect, the hydrophilic additive can be a polyethylene polymer grafted to an acrylic acid. The amount of acrylic acid grafted to the polyethylene polymer can generally be greater than about 0.5% by weight, such as in an amount greater than about 1% by weight, such as in an amount greater than about 2% by weight, such as in an amount greater than about 3% by weight, such as in an amount greater than about 4% by weight. The amount of acrylic acid grafted to the polyethylene polymer is generally less than about 25% by weight, such as less than about 15% by weight, such as less than about 12% by weight, such as less than about 10% by weight, such as less than about 8% by weight.

In one embodiment, once the acrylic acid is grafted to the polyethylene polymer, the acrylic acid can be saponified. Saponification can occur on the polymer resin or polymer particles or can occur after an article has been formed. In one aspect, the acrylic acid groups can be saponified by contacting the acrylic acid groups with a saponification agent. Any suitable saponification agent, such as a base, can be used. The saponification agent, for instance, can be a basic solution, such as a sodium hydroxide solution.

The hydrophilic additive may be a linear or branched, homopolymer or copolymer (e.g., random, graft, block, etc.) containing epoxy functionalization, e.g., terminal epoxy groups, skeletal oxirane units, and/or pendent epoxy groups. For instance, the hydrophilic additive may be a copolymer including at least one monomer component that includes epoxy functionalization. The monomer units of the hydrophilic additive may vary. For example, the hydrophilic additive can include epoxy-functional methacrylic monomer units. As used herein, the term (meth)acrylic generally refers to both acrylic and methacrylic monomers, as well as salts and esters thereof, e.g., acrylate and methacrylate monomers. Epoxy-functional (meth)acrylic monomers that may be incorporated in the hydrophilic additive may include, but are not limited to, those containing 1,2-epoxy groups, such as glycidyl acrylate and glycidyl methacrylate. Other suitable epoxy-functional monomers include allyl glycidyl ether, glycidyl ethacrylate, and glycidyl itoconate.

Examples of other monomers may include, for example, ester monomers, olefin monomers, amide monomers, etc. In one embodiment, the hydrophilic additive can include at least one linear or branched α-olefin monomer, such as those having from 2 to 20 carbon atoms, or from 2 to 8 carbon atoms. Specific examples include ethylene; propylene; 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene.

In one embodiment, the hydrophilic additive can be a terpolymer that includes epoxy functionalization. For instance, the hydrophilic additive can include a methacrylic component that includes epoxy functionalization, an α-olefin component, and a methacrylic component that does not include epoxy functionalization. For example, the hydrophilic additive may be poly(ethylene-co-methylacrylate-co-glycidyl methacrylate), which has the following structure:

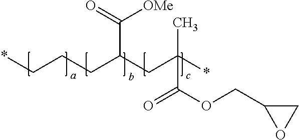

wherein, a, b, and c are 1 or greater.

In another embodiment the hydrophilic additive can be a random copolymer of ethylene, ethyl acrylate and maleic anhydride having the following structure:

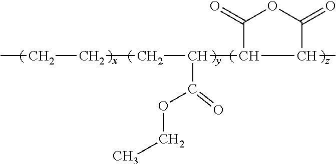

wherein x, y and z are 1 or greater.

The relative proportion of the various monomer components of a copolymeric hydrophilic additive is not particularly limited. For instance, in one embodiment, the epoxy-functional methacrylic monomer components can form from about 1 wt. % to about 25 wt. %, or from about 2 wt. % to about 20 wt % of a copolymeric hydrophilic additive. An α-olefin monomer can form from about 55 wt. % to about 95 wt. %, or from about 60 wt. % to about 90 wt. %, of a copolymeric hydrophilic additive. When employed, other monomeric components (e.g., a non-epoxy functional methacrylic monomers) may constitute from about 5 wt. % to about 35 wt. %, or from about 8 wt. % to about 30 wt. %, of a copolymeric hydrophilic additive.

The molecular weight of the above hydrophilic additive can vary widely. For example, the hydrophilic additive can have a number average molecular weight from about 7,500 to about 250,000 grams per mole, in some embodiments from about 15,000 to about 150,000 grams per mole, and in some embodiments, from about 20,000 to 100,000 grams per mole, with a polydispersity index typically ranging from 2.5 to 7.

In still another embodiment, the hydrophilic additive can be a surfactant that can be melt processed with the high-density polyethylene resin. For example, the surfactant can be a nonionic surfactant that is in the form of a solid at 23° C. In one aspect, for instance, the hydrophilic additive can be an alkyl polyethylene glycol ether. The alkyl polyethylene glycol ether can be made from linear saturated C10 to C28, such as C16-C18, fatty alcohols. For example, the surfactant can be the reaction product of a fatty alcohol with ethylene oxide. The surfactant can contain a degree of ethoxylation of greater than about 8 mols, such as greater than about 10 mols, such as greater than about 20 mols, such as greater than about 30 mols, such as greater than about 40 mols, and generally less than about 100 mols, such as less than about 80 mols, such as less than about 60 mols.

The hydrophilically modified polymer, such as a hydrophilically modified polyethylene polymer, can be present in the film in an amount greater than about 2% by weight, such as in an amount greater than about 5% by weight, such as in an amount greater than about 10% by weight, such as in an amount greater than about 15% by weight, such as in an amount greater than about 20% by weight, such as in an amount greater than about 30% by weight, such as in an amount greater than about 40% by weight, such as in an amount greater than about 50% by weight, and generally in an amount less than about 98% by weight, such as in an amount less than about 80% by weight, such as in an amount less than about 60% by weight, such as in an amount less than about 40% by weight, such as in an amount less than about 20% by weight, such as in an amount less than about 12% by weight.

In one aspect, the porous polymer film can be plasma oxidized in order to increase the hydrophilic properties. The plasma oxidation process can be used alone or in combination with one or more hydrophilic additives. An oxygen plasma treatment can not only greatly improve the compatibility of the porous polymer film with the electrolyte solution and increase ion conductivity but can do so without adversely impacting the mechanical properties of the film.

For example, in one aspect, the plasma process of the present disclosure is conducted using microwave discharge. In addition, the process can be carried out at very low pressures and at extremely short contact times so as to preserve the physical properties of the porous polymer film.

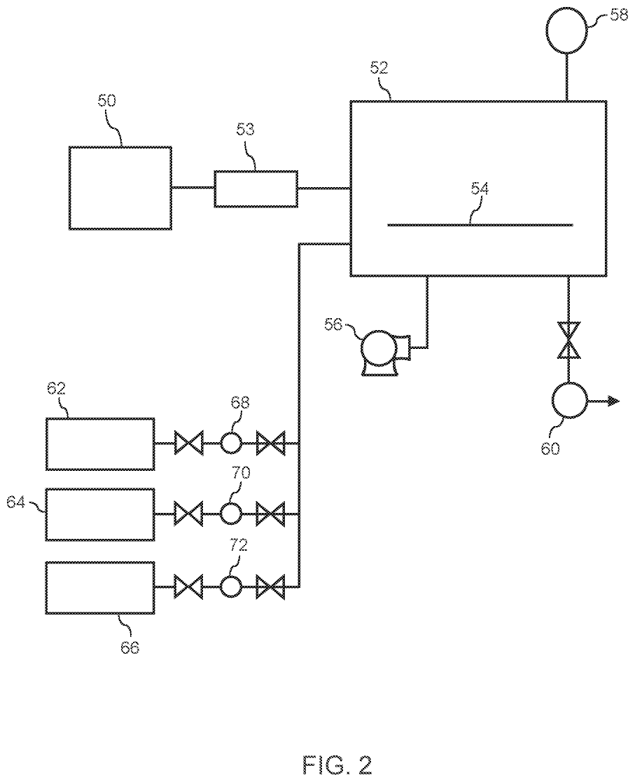

One embodiment of a plasma process that may be used in accordance with the present disclosure is shown in FIG. 2. Referring to FIG. 2, the plasma process includes a microwave supply 50 that is in communication with a vacuum chamber 52 via a resonant cavity 53. The resonant cavity 53 can include or be associated with an impedance matching system. A substrate holder 54 is contained within the vacuum chamber 52. The vacuum chamber 52 is also associated with a pressure monitoring device 58.

In order to evacuate the chamber 52, the chamber 52 can be placed in communication with a pump 56. The vacuum chamber 52 is also in communication with an exhaust 60.

As shown in FIG. 2, the vacuum chamber 52 can also be placed in fluid communication with one or more gas supplies. In the embodiment illustrated in FIG. 2, three different gas supplies are shown 62, 64, and 66. Each gas supply 62, 64, and 66 is placed in association with a corresponding mass flow rate controller 68, 70, and 72. The gas supplies 62, 64, and 66 are for feeding oxygen alone or in combination with other gases to the vacuum chamber 52.

As described above, in one embodiment, a microwave plasma reactor is used to deliver an oxygen plasma to the porous polymer films. Although other plasma reactors may be used in accordance with the present disclosure, in one embodiment, a low pressure plasma system with microwave discharge is preferred. Alternatively, an inductively coupled plasma system containing an RF generator may be used. The two reactors, however, differ in many different respects, including the conditions produced and the processes applied. When using microwave reactors, for instance, the porous polymer film samples can be placed outside of the active plasma zone, while in inductively coupled plasma reactors, the samples can be subjected to a significant amount of ion bombardment. Thus, the fluxes of charged particles that reach the sample can differ between the two processes.

During oxygen plasma treatment, a porous polymer film sample is placed into the vacuum chamber 52 and the chamber is evacuated using the pump 56. A plasma is then fed to the vacuum chamber 52 produced by the microwave supply 50 in conjunction with one or more gases that contain oxygen. Sources of oxygen can vary depending upon the particular application. In one embodiment, pure oxygen gas is fed to the vacuum chamber 52. In alternative embodiments, however, oxygen can be combined with other gases, such as inert gases. For instance, oxygen can be combined with nitrogen. In one embodiment, air is fed to the plasma chamber 52. Other sources of oxygen include hydrogen peroxide, water (steam), nitrous oxide, ozone, and the like. In one embodiment, the gas that is fed to the plasma chamber 52 contains greater than about 20% oxygen, such as greater than about 30% oxygen, such as greater than about 50% oxygen by volume.

During oxygen plasma treatment, an ionized gas is formed that contains various different positive and negative ions and optionally free radicals, photons, and neutral species. The ionized gas initiates reactions on the surface of the porous polymer film that ultimately modify the chemical properties of the surface. For instance, the polyethylene polymer can be oxidized in the presence of oxygen. The plasma oxidized surface, for instance, can contain various different polar groups that increase the polarity of the surface of the porous polymer film.

The conditions within the plasma chamber 52 during the plasma process can vary. In one embodiment, the oxygen plasma process is carried out at low pressures. For instance, the pressure within the chamber can be maintained below one atmosphere. For instance, the pressure within the chamber can be below about 10,000 pa, such as less than about 5,000 pa, such as less than about 1,000 pa, such as less than about 500 pa, such as less than about 300 pa, such as less than about 200 pa. In one embodiment, the process is carried out at very low pressures such as less than about 150 pa, such as less than about 130 pa, such as less than about 100 pa, such as less than about 80 pa, such as less than about 50 pa, such as less than about 30 pa. The temperature during the process can generally be less than about 60° C., such as less than about 50° C., such as less than about 40° C., such as less than about 30° C., such as less than about 28° C., such as less than about 25° C., and generally greater than about 15° C., such as greater than about 20° C.

In accordance with the present disclosure, the contact time between the porous polymer film and the oxygen plasma, in one embodiment, can be relatively short. For example, in one embodiment, each side of the porous polymer film can be exposed to the plasma for times of less than about 30 seconds, such as less than about 25 seconds, such as less than about 20 seconds, such as less than about 15 seconds, such as less than about 12 seconds, such as less than about 10 seconds, such as less than about 8 seconds, such as less than about 6 seconds. Contact times are generally greater than about 1 second, such as greater than about 2 seconds, such as greater than about 3 seconds. It was discovered that very short contact times provide the necessary ion conductivity without adversely impacting the physical properties of the film, especially when using microwave generated plasma at low pressures.

In order to form porous films in accordance with the present disclosure from the high-density polyethylene polymer and the one or more hydrophilic additives, the polymer composition is either gel extruded or sintered.

### Gel Extruded

When forming a gel extruded porous film, one or more high-density polyethylene polymers and one or more hydrophilic additives are combined with a plasticizer to form a gel and the resulting gel is fed through an extruding device. During the process of forming the film, the plasticizer can be substantially or completely removed from the resulting polymer article. For instance, the resulting article can contain the plasticizer in an amount less than about 10% by weight, such as in an amount less than about 5% by weight, such as in an amount less than about 2% by weight, such as in an amount less than about 1% by weight, such as in an amount less than about 0.5% by weight, such as in an amount less than about 0.1% by weight. The resulting article can contain the plasticizer in an amount of 0%, or greater than about 0.5% by weight, such as greater than about 1% by weight, such as greater than about 2% by weight.

The plasticizer, for instance, may comprise a hydrocarbon oil, an alcohol, an ether, an ester such as a diester, or mixtures thereof. For instance, suitable plasticizers include mineral oil, a paraffinic oil, decaline, and the like. Other plasticizers include xylene, dioctyl phthalate, dibutyl phthalate, stearyl alcohol, oleyl alcohol, decyl alcohol, nonyl alcohol, diphenyl ether, n-decane, n-dodecane, octane, nonane, kerosene, toluene, naphthalene, tetraline, and the like. In one embodiment, the plasticizer may comprise a halogenated hydrocarbon, such as monochlorobenzene. Cycloalkanes and cycloalkenes may also be used, such as camphene, methane, dipentene, methylcyclopentandiene, tricyclodecane, 1,2,4,5-tetramethyl-1,4-cyclohexadiene, and the like. The plasticizer may comprise mixtures and combinations of any of the above as well.

The plasticizer is generally present in the composition used to form the polymer articles in an amount greater than about 50% by weight, such as in an amount greater than about 55% by weight, such as in an amount greater than about 60% by weight, such as in an amount greater than about 65% by weight, such as in an amount greater than about 70% by weight, such as in an amount greater than about 75% by weight, such as in an amount greater than about 80% by weight, such as in an amount greater than about 85% by weight, such as in an amount greater than about 90% by weight, such as in an amount greater than about 95% by weight, such as in an amount greater than about 98% by weight. In fact, the plasticizer can be present in an amount up to about 99.5% by weight.

The high-density polyethylene particles, plasticizer, and one or more hydrophilic additives are blended together to form a homogeneous gel-like material and extruded through a die of a desired shape. In one embodiment, the composition can be heated within the extruder. For example, the plasticizer can be combined with the particle mixture and fed into an extruder. The plasticizer and particle mixture form a homogeneous gel-like material prior to leaving the extruder for forming polymer articles with little to no impurities.

During the process, at least a portion of the plasticizer is removed from the final product. The plasticizer removal process may occur due to evaporation when a relatively volatile plasticizer is used. Otherwise, an extraction liquid can be used to remove the plasticizer. The extraction liquid may comprise, for instance, a hydrocarbon solvent. Examples of extraction liquids, for instance, can be dichloromethane, trichloroethane, trichloroethylene, or mixtures thereof. Other extraction liquids include acetone, chloroform, an alkane, hexene, heptene, an alcohol, or mixtures thereof. In one embodiment, an extraction liquid is selected that also controls the amount of the molecular weight retention package that is removed from the composition.

In one aspect the resulting film is not drawn and is calendared by being fed through a nip of calendar rolls.

If desired, the resulting polymer article can be stretched at an elevated temperature below the melting point of the polyethylene polymer to increase strength and modulus. Suitable temperatures for stretching are in the range of from about ambient temperature to about 155° C. The draw ratios can generally be greater than about 4, such as greater than about 6, such as greater than about 8, such as greater than about 10, such as greater than about 15, such as greater than about 20, such as greater than about 25, such as greater than about 30. In certain embodiments, the draw ratio can be greater than about 50, such as greater than about 100, such as greater than about 110, such as greater than about 120, such as greater than about 130, such as greater than about 140, such as greater than about 150. Draw ratios are generally less than about 1,000, such as less than about 800, such as less than about 600, such as less than about 400. In one embodiment, lower draw ratios are used such as from about 4 to about 10. The polymer article can be uniaxially stretched or biaxially stretched.

### Sintered Film

In an alternative embodiment, the hydrophilic porous film of the present disclosure can be formed through a sintering process. During sintering, the polyethylene particles are compacted and formed into a solid mass without melting the polymer using heat and/or pressure. Sintering high-density polyethylene particles in accordance with the present disclosure produces porous structures having fluid capillaries that are well suited for ion permeability while remaining impermeable to gases. During sintering, relatively high molecular weight polymers are used. The polymers, for instance, can have an average molecular weight of greater than about 500,000 g/mol, such as greater than about 1,000,000 g/mol, such as greater than about 1,500,000 g/mol, such as greater than about 2,000,000 g/mol.

In one embodiment, the high-density polyethylene polymer selected for sintering has a very low melt flow rate or a melt flow rate that is too low to be measured.

In one aspect, one or more high-density polyethylene polymers in the form of particles are combined with one or more hydrophilic additives and any other desired additives and mixed together. For example, the components can be dry mixed using, for instance, a tumbler mixer, a motorized blender, or can be combined through shaking.

Porous articles, such as films, may be formed by a free sintering process which involves introducing the polyethylene polymer powder described above into either a partially or totally confined space, e.g., a mold, and subjecting the molding powder to heat sufficient to cause the polyethylene particles to soften, expand and contact one another. Suitable processes include compression molding and casting. The mold can be made of steel, aluminum or other metals. The polyethylene polymer powder used in the molding process is generally ex-reactor grade, by which is meant the powder does not undergo sieving or grinding before being introduced into the mold. The additives discussed above may of course be mixed with the powder.

The mold is heated in a convection oven, hydraulic press or infrared heater to a sintering temperature between about 140° C. and about 300° C., such as between about 160° C. and about 300° C., for example between about 170° C. and about 240° C. to sinter the polymer particles. The heating time and temperature vary and depend upon the mass of the mold and the geometry of the molded article. However, the heating time typically lies within the range of about 10 to about 100 minutes. During sintering, the surface of individual polymer particles fuse at their contact points forming a porous structure. Subsequently, the mold is cooled, and the porous article removed. In general, a molding pressure is not required. However, in cases requiring porosity adjustment, a proportional low pressure can be applied to the powder.

In one aspect, a porous polymer film can be produced through the sintering process. Alternatively, a cylindrically shaped porous article can be formed and fed through a skiving process to produce films having the desired properties and thicknesses.

In addition to one or more high-density polyethylene polymers and one or more hydrophilic additives, the polymer composition used to produce the porous film of the present disclosure can contain various other additives and components. For example, extruded or sintered films made according to the present disclosure can also contain heat stabilizers, light stabilizers, UV absorbers, acid scavengers, flame retardants, lubricants, colorants, and the like.

In one embodiment, a heat stabilizer may be present in the composition. The heat stabilizer may include, but is not limited to, phosphites, aminic antioxidants, phenolic antioxidants, or any combination thereof.

In one embodiment, an antioxidant may be present in the composition. The antioxidant may include, but is not limited to, secondary aromatic amines, benzofuranones, sterically hindered phenols, or any combination thereof.

In one embodiment, a light stabilizer may be present in the composition. The light stabilizer may include, but is not limited to, 2-(2′-hydroxyphenyl)-benzotriazoles, 2-hydroxy-4-alkoxybenzophenones, nickel containing light stabilizers, 3,5-di-tert-butyl-4-hydroxbenzoates, sterically hindered amines (HALS), or any combination thereof.

In one embodiment, a UV absorber may be present in the composition in lieu of or in addition to the light stabilizer. The UV absorber may include, but is not limited to, a benzotriazole, a benzoate, or a combination thereof, or any combination thereof.

In one embodiment, a halogenated flame retardant may be present in the composition. The halogenated flame retardant may include, but is not limited to, tetrabromobisphenol A (TBBA), tetrabromophthalic acid anhydride, dedecachloropentacyclooctadecadiene (dechlorane), hexabromocyclodedecane, chlorinated paraffins, or any combination thereof.

In one embodiment, a non-halogenated flame retardant may be present in the composition. The non-halogenated flame retardant may include, but is not limited to, resorcinol diphosphoric acid tetraphenyl ester (RDP), ammonium polyphosphate (APP), phosphine acid derivatives, triaryl phosphates, trichloropropylphosphate (TCPP), magnesium hydroxide, aluminum trihydroxide, antimony trioxide.

In one embodiment, a lubricant may be present in the composition. The lubricant may include, but is not limited to, silicone oil, waxes, molybdenum disulfide, or any combination thereof.

In one embodiment, a colorant may be present in the composition. The colorant may include, but is not limited to, inorganic and organic based color pigments.

In one aspect, an acid scavenger may be present in the polymer composition. The acid scavenger, for instance, may comprise an alkali metal salt or an alkaline earth metal salt. The salt can comprise a salt of a fatty acid, such as a stearate. Other acid scavengers include carbonates, oxides, or hydroxides. Particular acid scavengers that may be incorporated into the polymer composition include a metal stearate, such as calcium stearate. Still other acid scavengers include zinc oxide, calcium carbonate, magnesium oxide, and mixtures thereof.

These additives may be used singly or in any combination thereof. In general, each additive may be present in an amount of at least about 0.05 wt. %, such as at last about 0.1 wt. %, such as at least about 0.25 wt. %, such as at least about 0.5 wt. %, such as at least about 1 wt. % and generally less than about 20 wt. %, such as less than about 10 wt. %, such as less than about 5 wt. %, such as less than about 4 wt. %, such as less than about 2 wt. %. The sum of the wt. % of all of the components, including any additives if present, utilized in the polymer composition will be 100 wt. %.

After the hydrophilic porous polymer film of the present disclosure is formed, the film can be directly incorporated into an electrolysis cell as shown in FIG. 1. Optionally, a hydrophilic coating can be applied to one or both sides of the film. The coating can comprise silica, aluminum oxide, zirconium oxide, or any of the other hydrophilic inorganic materials described above. In one embodiment, both sides of the film are coated with a hydrophilic coating.

For example, in one embodiment, a dope solution can be coated onto each side of the film using, for instance, an extrusion coating process. The dope solution can comprise, for instance, a polymer resin combined with hydrophilic particles and a solvent. The hydrophilic particles can comprise any of the hydrophilic inorganic particles described above. The organic solvent can be selected in which the polymer resin is dissolved. The solvent can be inorganic solvent that is miscible in water. Examples of solvents include N-methyl-pyrrolidone, N-ethyl-pyrrolidone, N-butyl-pyrrolidone, N,N-dimethylformamide, formamide, dimethyl sulfoxide, N,N-dimethylacetamide, acetonitrile, or mixtures thereof.

The polymer resin can comprise a fluoropolymer, such as polytetrafluoroethylene. Alternatively, the polymer resin can be an olefin resin, such as polyethylene or polypropylene, polyethylene terephthalate, or polystyrene. In one aspect, the polymer resin is a vinylidene fluoride.

The dope solution may also optionally contain various other components such as organic or inorganic compounds. Organic compounds that may be present include polyethylene glycol, polyethylene oxide, polypropylene glycol, ethylene glycol, tripropylene glycol, glycerol, polyhydric alcohols, dibutyl phthalate, diethyl phthalate, diundecyl phthalate, isononanoic acid, polyvinyl pyrrolidone, polyvinyl alcohol, polyvinyl acetate, polyethylene imine, polyacrylic acid, methylcellulose, dextran, or mixtures thereof.

After the film is coated with the dope solution, the dope solution can be subjected to phase inversion in order to transform the dope into a porous hydrophilic coating.

The phase inversion step includes a so-called Liquid Induced Phase Separation (LIPS) step, a Vapour Induced Phase Separation (VIPS) step or a combination of a VIPS and a LIPS step. Both LIPS and VIPS are non-solvent induced phase-inversion processes.

In a LIPS step the support coated with a dope solution is contacted with a non-solvent that is miscible with the solvent of the dope solution. Typically, this is carried out by immersing the support coated with a dope solution into a non-solvent bath, also referred to as coagulation bath. The non-solvent can be water, mixtures of water and an aprotic solvent selected from the group consisting of N-methylpyrrolidone (NMP), dimethylformamide (DMF), dimethylsulfoxide (DMSO) and dimethylacetamide (DMAC), water solutions of water-soluble polymers such as PVP or PVA, or mixtures of water and alcohols, such as ethanol, propanol or isopropanol.

The temperature of the bath can be between 20 and 90° C., such as between 40 and 70° C.

The transfer of solvent from the coated polymer layer towards the non-solvent bath and of non-solvent into the polymer layer leads to phase inversion and the formation of a three-dimensional porous polymer network. The impregnation of the applied dope solution into the support results in a sufficient adhesion between the obtained hydrophilic layers onto the porous film.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. A separator for dividing an anode from a cathode comprising:
a porous polymer film, the porous polymer film comprising a high-density polyethylene polymer having a number average molecular weight of greater than about 500,000 g/mol, the film having a thickness of from about 5 microns to about 600 microns, the porous polymer film
(a) containing a hydrophilic additive, the hydrophilic additive being present in the porous polymer film in an amount of at least about 5% by weight; and/or
(b) having been plasma oxidized to increase the hydrophilic properties of the film.

2. A separator as defined in claim 1, wherein the porous polymer film has a porosity of from about 25% to about 85%.

3. A separator as defined in claim 1, wherein the high-density polyethylene polymer has a number average molecular weight of greater than about 600,000 g/mol and less than about 12,000,000 g/mol.

4. A separator as defined in claim 1, wherein the porous polymer film comprises an extruded film that has been stretched in at least one direction or has been calendared.

5. A separator as defined in claim 1, wherein the porous polymer film comprises a sintered film.

6. A separator as defined in claim 1, wherein the porous polymer film has a thickness of from about 5 microns to about 500 microns.

7. A separator as defined in claim 1, wherein the separator is a single layer porous polymer film that may optionally include a coating.

8. A separator as defined in claim 7, wherein the single layer porous polymer film includes a coating, the coating comprising silica, aluminum oxide, or zirconium oxide.

9. A separator as defined in claim 7, wherein the single layer porous polymer film includes a hydrophilic coating on each side of the porous polymer film.

10. A separator as defined in claim 1, wherein the separator is polypropylene-free.

11. A separator as defined in claim 1, wherein the film contains the hydrophilic additive, the hydrophilic additive comprising inorganic particles, the inorganic particles having a particle size D50 of 20 μm or less.

12. A separator as defined in claim 11, wherein the hydrophilic additive is present in the porous polymer film in an amount of at least about 10% by weight and less than about 90% by weight.

13. A separator as defined in claim 1, wherein the porous polymer film has an average pore size of greater than about 0.005 microns and less than about 1 micron.

14. A separator as defined in claim 11, wherein the hydrophilic additive comprises silica, alumina, zirconium oxide, zirconium hydroxide, magnesium oxide, magnesium hydroxide, titanium oxide, titanium hydroxide, barium sulfate, or mixtures thereof.

15. A separator as defined in claim 11, wherein the hydrophilic additive comprises a hydrophilically modified polyethylene polymer.

16. A separator as defined in claim 11, wherein the hydrophilic additive comprises a fumed silica.

17. A separator as defined in claim 1, wherein the porous polymer film has an ionic resistance of less than 0.1 ohm·cm² at 80° C. in a 30 wt % aqueous KOH solution.

18. A separator as defined in claim 1, wherein the film has been plasma oxidized.

19. A separator as defined in claim 18, wherein the film has been plasma oxidized to form polar groups attached to the high-density polyethylene polymer that increases the polarity of the surface of the porous polymer film.

20. A water electrolysis device comprising a separator as defined in claim 1 located between a cathode and an anode.
